(19) United States
(12) Patent Application Publication
(10) Pub. No.: US 2023/0325565 A1
(43) Pub. Date: Oct. 12, 2023

(54) SIMULATION OF A COMBUSTION CHAMBER BY COUPLING A LARGE-SCALE SOLVER AND A MULTILAYER NEURAL NETWORK

(71) Applicant: BULL SAS, LES CLAYES SOUS BOIS (FR)

(72) Inventors: Gaël GORET, Réaumont (FR); Christophe BOVALO, Grenoble (FR); Alexis GIORKALLOS, Montaud (FR); Léo NICOLETTI, Cuisia (FR); Rami SALEM, Grenoble (FR)

(73) Assignee: BULL SAS, LES CLAYES SOUS BOIS (FR)

(21) Appl. No.: 18/124,676

(22) Filed: Mar. 22, 2023

(30) Foreign Application Priority Data
Mar. 22, 2022 (EP) 22163424.9

(51) Int. Cl. G06F 30/15; G06F 30/28; G06F 30/27

(52) U.S. Cl. CPC G06F 30/28; G06F 30/15; G06F 30/27

(57) ABSTRACT

A method for simulating the combustion of a fluid in a combustion chamber, for the design of said combustion chamber, which includes: discretizing the space of the chamber into a given mesh; training a neural network by means of a learning set associating a graph corresponding to the mesh, the vertices of which have, as a value, progress variables predicted by a computational fluid dynamics simulation with local combustion quantities at these vertices; and an iterative simulation phase, where: the values predicted by the neural network of a local combustion quantity at the vertices of the mesh are provided as input to a solver, in order to obtain a value of a progress variable at each vertex of said mesh, and a graph corresponding to the vertices of the mesh is provided to said neural network, each vertex having a corresponding value of said progress variable, obtained by said solver, in order to obtain predicted values of the local combustion quantity at said vertices.

### TECHNICAL FIELD

The present invention relates to the design and industrial manufacture of combustion chambers, especially for air vehicles such as helicopters. It aims in particular to improve the simulation of such combustion chambers in order to allow the improvement of their performance.

### BACKGROUND

Thermodynamic rotary machines aim to produce mechanical energy in the form of the rotation of a shaft, directly from the kinetic energy of the gases produced by the combustion of a hydrocarbon (fuel oil, fuel gas, etc.) which undergo expansion in a turbine. The oxidizer, most often ambient air, is generally compressed before entering the combustion chamber, using a rotary compressor driven by the same shaft as the turbine. The compressor may be of the axial type, with several compressor stages arranged one after the other on an axis, or of the centrifugal type, of a large diameter and expelling the compressed air through the ends.

These machines, typically turboshaft engines, can be used in different use cases, like as the propulsion of vehicles such as helicopters, ships, or as turbines, in electrical power plants for example.

The design of the combustion chamber is critical because it is subjected to high thermodynamic stresses (high temperatures etc.). Furthermore, in the case of vehicles, especially air vehicles, they are subjected to weight constraints affecting the choice of materials.

The design parameters (dimensions, shape, etc.) of the combustion chamber form a space with considerable possibilities which, in practice, causes the combustion chambers not to be designed optimally.

In order to improve the situation, simulation mechanisms have been implemented, in order to make it possible to navigate all or part of the set of possibilities in order to determine the design parameters

These mechanisms make it necessary to simulate fluid combustion behavior in order to determine its impact on the combustion chamber, this behavior itself being influenced by the design parameters of the chamber.

Various simulation tools have been proposed in order to estimate the impact of each design choice and thus to explore a larger number of possibilities that it would not be conceivable to do in actual tests. It is especially possible to determine the impact of each design choice of the combustion chamber by simulating the including of the combustion thereof, and to draw conclusions from same on the cost of manufacturing the chamber, the performance of the combustion, the fuel consumption, the wear of the chamber over time, etc.

In manufacturing engineering, this iterative process is referred to as “generative design”.

Digital simulation tools can implement “Computational Fluid Dynamics” (CFD) techniques. Mention may be made, for example, of the software sold by the company Dassault Systems, such as the “Simulia” software product. Mention may also be made of the “Flow Simulator” software from the company HyperWorks, with different physics simulation modules (“elsA” produced by ONERA, “Su2” from Stanford University, etc.), or else the AVBP software developed by the CERFACS (European Center for Research and Advanced Training in Scientific Computation).

Computational fluid dynamics (CFD) consists in studying the movements of a fluid (for example air) and the effects of such movements by numerically solving the equations governing the fluid. Based on the approximations chosen, which are generally the result of a compromise in terms of the requirements of physical representation with respect to the available computation or modeling resources, the solved equations can be the Euler equations, the Navier-Stokes equations, etc.

However, these tools involve very significant computation times, which do not make it possible to navigate all the possibilities and therefore do not make it possible to determine the optimal parameters for the design of a combustion chamber.

Solutions have been proposed which offset the simulation computation toward the use of constant-time predictive models such as deep neural networks.

Mention may be made, for example, of the article by Corentin J. Lapeyre, Antony Misdariis, Nicolas Cazard, Denis Veynante, and Thierry Poinsot, “Training convolutional neural networks to estimate turbulent sub-grid scale reaction rates” (2019) Combustion and Flame, 203. 255-264. ISSN 0010-2180.

This article proposes the use of a “Convolutional Neural Network” (CNN), in collaboration with a conventional tool implementing a computational fluid dynamics simulation.

In practice, the latter (generally referred to as “solvers”) work on an adaptive discretization of the space studied, the computation points forming a mesh that is denser in the places where the computed data are more variable and, on the contrary, looser when the data are more invariable (that is to say, further from where combustion takes place). However, neural networks, and in particular convolutional networks, generally operate on a fixed mesh.

It follows that the methods of the state of the art, and especially that disclosed in the article hereinbefore, require steps of interpolation and re-interpolation in order to switch from the workspace of the solver to that of the neural network and vice versa, at each iteration of an iterative process.

These interpolation steps are expensive in terms of digital processing and absorb a large part of the computation time saved by the use of neural networks.

Furthermore, they can generate inaccuracies that may adversely affect the convergence of the iterative process and the accuracy of the simulated result.

In many cases, even, the interpolation is not possible. Indeed, the neural network learns physics at a given scale. If the mesh is non-uniform, it is necessary to project (or interpolate) the mesh toward a uniform mesh. However, this amounts to choosing the finest cells of the non-uniform mesh and subdividing the largest meshes. In doing so, an immense number of cells must be added in the simple zones, which makes the size of the mesh prohibitive.

### BRIEF SUMMARY

One aim of the present invention is to improve the situation by making it possible, especially, to reduce the computation time necessary for the simulation and to improve the accuracy thereof.

It is thus possible, in an identical time, to test a larger number of possibilities of the design parameters of the combustion chamber, and therefore to statistically obtain a better solution, or to obtain an optimal parameter set in a shorter time. Generally, it is thus possible to obtain better performance for the combustion chambers thus produced.

For this purpose, according to a first aspect, the present invention can be implemented by a method for simulating the combustion of a fluid in a combustion chamber, for the design of said combustion chamber, which includes
discretizing the space of said combustion chamber into a given mesh,
a phase of training a multilayer neural network by means of a learning set associating a graph corresponding to said given mesh, the vertices of which have, as a value, progress variables predicted by a computational fluid dynamics simulation, with local combustion quantities at said vertices, and according to a loss function configured to minimize an error between the output of said neural network and said local combustion quantities;
an iterative phase of simulating said combustion which involves, at each iteration,
providing as input to a solver the values predicted by said multilayer neural network of a local combustion quantity at the vertices of said given mesh, in order to obtain a value of a progress variable at each vertex of said given mesh,
providing to said multilayer neural network a graph corresponding to the vertices of said given mesh, each vertex having a corresponding value of said progress variable, obtained by said solver, in order to obtain predicted values of said local combustion quantity at said vertices.

According to preferred embodiments, the invention comprises one or more of the following features, which may be used separately or in partial combination with one another, or in full combination with one another:
said local combustion quantity is approximated by a flame surface density;
the method includes a step of discretization of said space into a second mesh, substantially finer than said given mesh, and said training phase comprises a direct numerical simulation of said combustion, in order to obtain said progress variables and said local combustion quantities at the vertices of said second mesh, then a filtering in order to obtain said progress variables and said local combustion quantities at the vertices of said given mesh;
the nodes of said graph match the vertices of said given mesh;
said solver performs a large-scale simulation;
said multilayer neural network takes into account said graph by computing the state of a neuron from the states of the neurons of a neighborhood determined by said graph;
the state of a neuron is computed based on an influence of said neighboring neurons that is variable according to said neighboring neurons;
the method further includes a step of determining a set of design parameters for said combustion chamber from the results of said iterative simulation phase for a plurality of envisaged design parameters.

According to a second aspect, the invention can also be implemented by a device for simulating the combustion of a fluid in a combustion chamber, for the design of said combustion chamber, which includes
means for discretizing the space of said combustion chamber into a given mesh,
means for training a multilayer neural network by means of a learning set associating a graph corresponding to said given mesh, the vertices of which have, as a value, progress variables predicted by a computational fluid dynamics simulation, with local combustion quantities at said vertices, and according to a loss function configured to minimize an error between the output of said neural network and said local combustion quantities;
a solver suitable for receiving as input the values predicted by said multilayer neural network of a local combustion quantity at the vertices of said given mesh, in order to obtain a value of a progress variable at each vertex of said given mesh,
said multilayer neural network being suitable for receiving as input a graph corresponding to the vertices of said given mesh, each vertex having a corresponding value of said progress variable, obtained by said solver, in order to obtain predicted values of said local combustion quantity at said vertices.

Other features and benefits of the invention will become apparent upon reading the following description of a preferred embodiment of the invention, given by way of example with reference to the appended drawings

### BRIEF DESCRIPTION OF THE FIGURES

The appended drawings illustrate the invention:

FIG. 1 schematically depicts an example of a combustion chamber.

FIG. 2 very schematically illustrates a neural network.

FIG. 3 depicts a flowchart of a method according to one embodiment of the invention.

FIG. 4 illustrates an example of non-uniform mesh.

FIG. 5 depicts a functional schematic view of a training phase of a multilayer neural network according to one embodiment of the invention.

FIG. 6 depicts a functional schematic view of an iterative simulation phase according to one embodiment of the invention.

### DETAILED DESCRIPTION

One of the aims of the invention is to improve, by making it more effective, the simulation of combustion phenomena, and especially of turbulent combustion, in combustion chambers, in order to allow the optimization of the various design parameters (dimensions, shape, materials, etc.) of this chamber and, possibly, other combustion parameters (fuel mixture, etc.).

As mentioned previously, combustion chambers can be used for the propulsion of vehicles such as helicopters, ships, or as turbines, in electrical power plants for example. These combustion chambers may especially be used in turboshaft engines or other thermodynamic rotary machines, or turbine engines.

The parameters to be optimized depend on the use case and must therefore be determined again for each new application.

The design of the combustion chamber is critical because it is subjected to high thermodynamic stresses (high temperatures etc.). Furthermore, in the case of vehicles, especially air vehicles, they are subjected to weight constraints affecting the choice of materials.

FIG. 1 schematically depicts a possible compression chamber, only by way of illustration and without loss of generality. Other chamber architectures are also possible, especially according to the intended application, especially annular chambers.

The arrow 101 depicts the compressed air which exits a compressor, not shown. It is split into two currents, one 108a, 108b which cools the walls, the other which penetrates directly into the combustion chamber 104, 105, 106, where it serves as oxidant for the fuel injected into the central part by an injector 102.

The combustion chamber is provided for the air to be in a slight surplus, so that the flame 103 reaches a high temperature (typically up to 2500 K in the primary region 104.

Via holes arranged at the periphery of the chamber, the outside air returns (arrow 108b) to mix with the burnt gases in the transient region 105, where the temperature drops back down to about 2000 K, and then in the dilution region 106, where the aim is to produce a gas flow with a temperature that is as stable as possible in order to avoid the risk of local or momentary overheating.

The air is then ejected towards a turbine 107,

This example of a combustion chamber is given purely by way of illustration. Other types of combustion chambers exist (silo chambers, annular chambers, etc.), to which the invention can also be entirely applied.

Combustion within a combustion chamber is an extremely complex phenomenon. Many parameters greatly influence the efficiency of the combustion, the wear of the constituent materials of the chamber, etc. In parallel, many external stresses also affect the design of the combustion chamber, linked especially to the intended application. Thus, a combustion chamber on board a helicopter, for example, must comply with size and weight constraints.

Generally, a combustion chamber must meet strict general constraints:
providing complete combustion of the fuel;
reducing pollutant emissions;
minimizing the pressure loss (which represents extra compression);
ensuring good stability of the temperature at the turbine inlet;
occupying as small a volume as possible while allowing good cooling of the walls.

Under such circumstances, the design (with a view to manufacturing) of a combustion chamber for a given application requires a computer-assisted simulation phase in order to define the various parameters thereof. Various sets of parameters (fuel, shape, size of the chamber, etc.) can be simulated in order to ultimately choose a set that is satisfactory. The combustion chamber may then be designed (and enter production) on the basis of this set of parameters.

The simulation according to the invention is automated by computer tools using different algorithmic technologies. It relies on a coupling between a solver and a particularly suitable multilayer neural network.

A solver is a software tool suitable for solving a numerical simulation problem. This tool can interface with a simulation platform that offers other functionalities, such as the aggregation of several solvers (each suitable for specific issues), visualization tools, human-machine interfaces, export tools, tools for discretization of the study space, etc.)

One example of a solver is the “simpleFOAM” solver that can be used on the “OpenFOAM” open-source platform. The software and its documentation are available on the project’s website: https://www.openfoam.com.

Other platforms for CFD simulation exist, such as especially the software marketed by the company Dassault Systems, such as the “Simulia” software product. Mention may also be made of the “Flow Simulator” software from the company HyperWorks, with different physical simulation modules, or solvers: “elsA” produced by ONERA, “Su2” from Stanford University, etc.

These various software platforms implement Computational Fluid Dynamics (CFD) techniques in order to determine the interactions of a fluid with its environment, and in particular during combustion.

Computational fluid dynamics (CFD) consists in studying the movements of a fluid (herein a mixture of oxidant and fuel) and the effects of such movements by numerically solving the equations governing the fluid. Based on the approximations chosen, which are generally the result of a compromise in terms of the requirements of physical representation with respect to the available computation or modeling resources, the solved equations can be the Euler equations, the Navier-Stokes equations, etc.

Furthermore, according to the invention, the simulation of the combustion is also based on the use of a multilayer neural network.

In very macroscopic terms, multilayer neural networks can be seen as black boxes whose internal parameters must be adjusted during a learning or training phase, by presenting them with both input data and a desired output (or “label”). The error between this desired output and the “natural” output of the network makes it possible to slightly adjust the parameters in order to decrease the error. By having a large number of these “input data/desired output data” pairs, the network learns to react correctly and to provide a correct output when it is presented with new unlabeled input data.

According to the invention, the neural network used is a multilayer neural network.

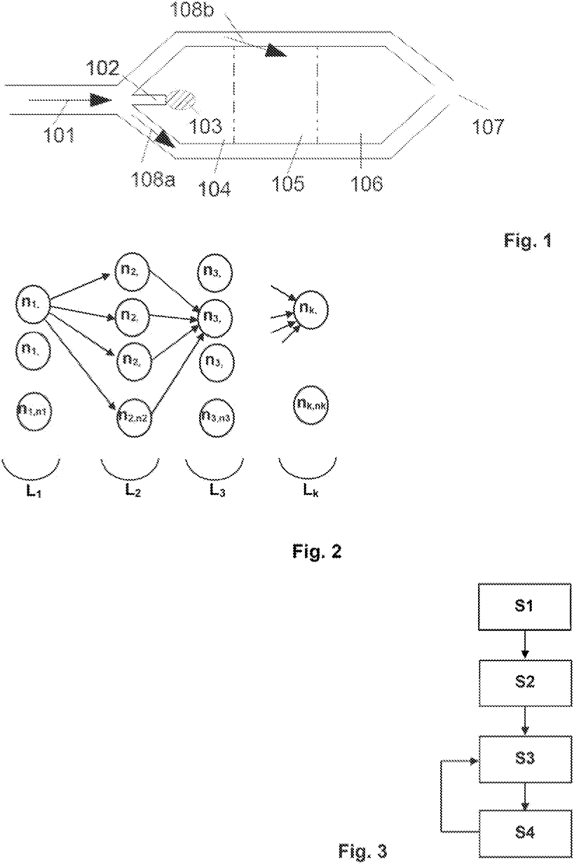

FIG. 2 illustrates a greatly simplified example of a multilayer neural network.

A multilayer neural network (MNN) is a type of artificial neural network organized into several layers within which an item of information circulates from the input layer L1 to the output layer Lk only; it is therefore a “feedforward” network. Each layer L1, L2, L3 ... Lk consists of a variable number of neurons n1, n2, n ... nk, respectively. The neurons of the last layer (referred to as “output layer”) are the outputs of the neural network and representative of a prediction of the model in response to an input supplied to the layer L1. The layers between the input layer L1 and the output layer Lk are referred to as “hidden layers” since they do not normally have interfaces with the outside.

In a multilayer network, each neuron ni,j is potentially connected at the output to all of the neurons of the next layer Li+1. Conversely, it receives as input the outputs of all of the neurons of the previous layer Li-1. In FIG. 2, for clarity, only a few connections are depicted by oriented arrows.

Each connection is associated with a weight. The set of weights forms the internal parameters of the neural network. They must be determined during a learning (or training) phase and then make it possible to predict output values, by generalization, from a new input vector presented on the input layer L1.

Each neuron ni,j conventionally calculates a weighted sum of these inputs by the weights of the associated connections, then applies to this sum an activation function.

Several techniques exist for determining the internal parameters of the network, the thresholds, by learning. Mention may especially be made of the Stochastic Gradient Descent (SGD) algorithm, disclosed for example in LeCun, Yann A., et al. “Efficient backprop. Neural networks: Tricks of the trade”, Springer Berlin Heidelberg, 2012. 9-48. Mention may also be made of ADAM, disclosed initially in Diederik P. Kingma and Jimmy Lei Ba. “Adam: A method for stochastic optimization”. 2014. arXiv:1412.6980v9, or RMSprop, disclosed especially in Tijmen Tieleman and Geoffrey Hinton, “Lecture 6.5-rmsprop: Divide the gradient by a running average of its total magnitude”, COURSERA: neural networks for machine learning, 4(2): 26-31, 2012.

One of the aspects of the invention consists in allowing the learning and the determination of all or part of the parameters of the multilayer neural network.

In particular, coupling between the multilayer neural network and a conventional simulation based on computational fluid dynamics (CFD) makes it possible to determine parameters of the neural network, by learning, as will be seen below.

The parameters of the neural network comprise especially:
the internal parameters, or weights, or even synaptic weights, associated with the connections between neurons, and being determined iteratively by the learning (or training);
meta-parameters determining the architecture of the neural network: numbers of layers, numbers of neurons in each layer, etc.;
the data of the learning set, which make it possible to determine the weights;
the loss function that makes it possible to estimate the error at the output of the neural network and to determine, by back-propagation, the adjustments to be made to the weights of the network for each data item of the learning set;
the convolution kernels, in the case of an embodiment based on convolutional neural networks.

Generally speaking, the training phase aims to determine, by convergence, the synaptic weight values. For a given network, all of these values form a model representative of the learning set.

Once the learning has been completed, the synaptic weights are fixed, and, on the basis of this model, the neural network can be used in prediction by submitting to it new input vectors (not present in the learning set) in order for it to generate, or “predict”, an output vector.

FIG. 3 depicts a flowchart illustrating a method according to one embodiment of the invention, which aims to simulate, using computer tools, the combustion of a fluid in a combustion chamber.

This simplified flowchart depicts the steps sequentially for the clarity of the description, but, according to variants, the steps may potentially be ordered differently, and especially, interleaved.

In a step S1, the simulation method comprises a discretization of the space of the combustion chamber into a given mesh.

It is known per se to provide such a step insofar as the various solvers and the computational fluid dynamics (CFD) tools operate on this general principle of discretization of the space studied. The issue is thus to consider input values at the vertices of the mesh and to determine simulated output values on these same vertices.

Generally, in the computational fluid dynamics (CFD) model, small cells or elements are created to fill the volume in which the flow or, herein, the combustion is to be simulated. They constitute a mesh where each cell represents a discrete space which locally represents the physical phenomenon. The mathematical equations which represent the physics are then applied to each cell of the mesh. The generation of a high-quality mesh is extremely important in obtaining reliable solutions and guaranteeing numerical stability.

Many papers are available on this subject of the meshing of the simulation space. By way of example, one may consult Chapter 6, “Computational Meshing for CFD Simulations” by A. Lintermann, in the collective work “Clinical and Biomedical Engineering in the Human Nose - A Computational Fluid Dynamics Approach”, Singapore: Springer Nature Singapore Pte Ltd. 2021, Biological and Medical Physics, Biomedical Engineering 85-115 (2020)

When the physical phenomenon is not homogeneous in the static space, the mesh can also be non-homogeneous, that is to say it can have vertices that are closer together in the places where the phenomenon is less homogeneous and vertices that are more spaced apart in the places of greater homogeneity of the simulated physical phenomenon.

Generally speaking, this information is known in advance and the mesh can therefore be provided in advance. For example, in the context of a combustion, the mesh may be finer near the flame and on the walls of the chamber, and looser in other locations.

As will be seen below, one of the benefits of the invention is to allow a relatively loose mesh while retaining the accuracy and convergence properties of the computational fluid dynamics techniques.

The simulation method likewise includes a training phase, S2, of training a multilayer neural network.

As seen previously, this step aims to fix internal parameters of the neural network so that the latter models a phenomenon reflected by the learning set in order to subsequently be used in prediction. To do this, the learning set must be prepared appropriately.

Generally speaking, a learning set associates an input vector (which corresponds to what is supplied to the input layer of the neural network) with a desired output vector (or label), which is compared, by means of a “loss function”, to the actual output of the neural network.

According to the invention, this learning set associates a graph corresponding to the mesh, the vertices of which have progress variables as values, with local combustion quantities at these vertices.

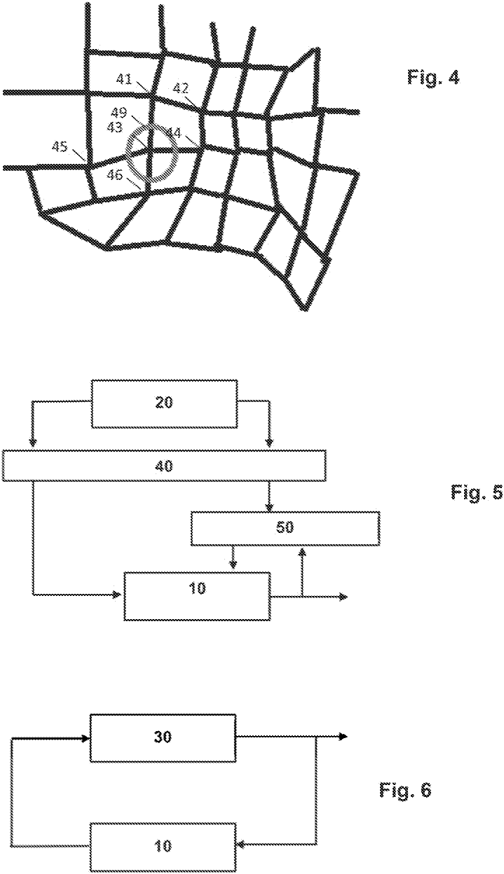

FIG. 4 illustrates an example of a mesh. For the sake of clarity of the figure, this mesh is depicted in two dimensions, but, in the general case, a three-dimensional mesh is provided in order to cover the whole of the simulated space.

This mesh is non-uniform because it is adaptive: it is tighter, or fine, when the simulated physics are more complex, that is to say, involving greater value variations in the space. This may be due to turbulence, combustion, etc.

One value of a progress variable corresponds to each vertex 41, 42, 43, 44, 45 and 46.

The progress variables form the object of the simulation and are representative of the state of progress of the combustion (they are sometimes likewise referred to as “advance variables”)

Changes in the progress variables thus make it possible to estimate the quality of the combustion over time. By playing with the parameters of the combustion chamber, the changes in the progress variables are modified, so that the study of said combustion chamber makes it possible to estimate whether or not the parameters of the selected combustion chamber match the requirements.

Various progress variables can be used, as long as they make it possible to estimate a combustion quality, and therefore, ultimately, to define the parameters of the combustion chamber.

A fairly complete panorama on the notion of progress variable can be found in the thesis by Aimad Er-Raiy, “Étude des processus élémentaires impliqués en combustion à volume constant”, ISAE-ENSMAEcole Nationale Supérieure de Mécanique et d′ Aérotechnique - Poitiers, 2018, NNT: 2018ESMA0019, tel-02080286.

For example, it is possible to use c as progress variable for adiabatic gases:

$$c = \frac{T - {T}_{u}}{{T}_{b} - {T}_{u}}$$

where Tᵤ is the fresh gas temperature, T_{b} is the burnt gas temperature and T is the local gas temperature.

It can be seen that c=0 for the fresh gases and c=1 for the burnt gases; c=0.5 corresponds to the points of maximum probability of the flame front. The iso-contour at c=0.5 can therefore represent this flame front.

A local combustion quantity is likewise associated with these vertices. This local combustion quantity is representative of the combustion behavior near the corresponding vertex.

This combustion quantity can be approximated by a flame surface density (FSD).

The term “flame surface density Σ” is the measurement of the flame surface available per unit of volume. It was defined in S. B. Pope, “The evolution of surfaces in turbulence”, in International Journal of Engineering Science, 26(5):445-469, 1988.

The combustion quantities and the progress variables represent the local combustion phenomena. Their values are assigned to a vertex and they can be considered to be valid in a region substantially smaller than the size of the mesh around the vertex in question.

Thus, in FIG. 4, a region 49 is depicted for the vertex 43. The size of this region 49 is substantially less than the distance which separates, in space, the vertex 43 from the neighboring vertices 41, 42, 44, 45 and 46. This region has a larger radius substantially smaller than the distance from the vertex 43 to its closest neighbor.

The values and quantities used for training are provided by a computational fluid dynamics (CFD) simulator.

In particular, a direct numerical simulation (DNS) approach can be used.

The term direct numerical simulation was introduced for the first time in Orszag, Steven A. (1970), “Analytical Theories of Turbulence”, Journal of Fluid Mechanics, 41 (1970): 363-386. It designates a computational fluid dynamics (CFD) simulation method, in which the Navier-Stokes equations are numerically solved.

This type of simulation has the advantage of being very accurate since it does not involve any simplification of the model or reduction of data, but this accuracy has as its counterpart a computational cost which, in general, restricts it to academic uses.

Indeed, it can be estimated that the number of numerical operations (floating point) for a simulation is proportional to the number of points in the mesh and to the number of iterations in the simulation. This number of operations increases with the cube of the Reynolds number, which characterizes the inertia and viscosity specific to a fluid. The higher this number, the more turbulence the combustion fluid tends to generate. However, even with a low Reynolds number, the computational cost of a DNS-type simulation is therefore extremely high.

The dedicated Wikipedia page provides additional information about this type of simulation:

https://en.wikipedia.org/wiki/Direct numerical simulation

Among the available tools that can perform direct numerical simulations, the previously mentioned tools propose suitable modules, especially the software marketed by the company Dassault Systems, such as the “Simulia” software product. Mention may also be made of the “Flow Simulator” software from the company HyperWorks, with different physics simulation modules (“elsA” produced by ONERA, “Su2” from Stanford University, etc.), or else the AVBP software developed by the CERFACS (European Center for Research and Advanced Training in Scientific Computation).

According to one embodiment of the invention, direct numerical simulation is carried out on a substantially finer mesh than that used for the learning of the neural network. In other words, two meshes can be used.

This fine mesh makes it possible to take advantage of the accuracy inherent in direct numerical simulation.

FIG. 5 illustrates the training phase S2 of the neural network 10. This figure schematically shows the various functions implemented by this training (or learning) phase.

These functions can be implemented by discrete software modules or tools according to embodiments of the invention. Conversely, some functions may be grouped together in a single software module or tool.

Reference 20 depicts direct numerical simulation.

The data provided by the direct numerical simulation comprise a progress value and a local combustion quantity (approximated for example by a flame surface density) for each point of a fine mesh.

These data are then filtered by a filtering (or sub-sampling) function 40, in order to constitute a coarser mesh. The terms “fine” and “coarse” relate to the distance between two consecutive vertices of the mesh. The coarser mesh corresponds to a scale typically used in large-scale simulations (“Large-Eddy Simulations”, LES).

According to one embodiment, a factor 8, according to each dimension, can be used between these two meshes. For example, the finest mesh (used for direct numerical simulation) can divide the simulation space into 512x256x256 cells, while the coarsest mesh can divide this same space into 64x32x32 cells. The final mesh is therefore 512 times (8³) less dense than the initial mesh, which is the finest.

The vertices of the coarsest mesh may coincide with the vertices of the initial mesh, the finest, especially in the case of uniform meshes.

This filtering consists in “aggregating” the behavior of the combustion as modeled on the finest mesh, over a smaller number of meshes. In other words, it involves assigning the progress variable values and the local combustion quantities that best represent the region covered by each mesh vertex.

For example, for a quantity Q, a filtered quantity Q̅can be produced

$$\overline{Q \left(x , t\right)} = {\int }_{Δ} {F}_{Δ} \left(x - {x}^{′}\right) . Q \left({x}^{′} , t\right) d {x}^{′}$$

This quantity Q may be the progress variable c, the flame surface density Σ or any other estimation of the local combustion quantity.

F_{Δ} represents a spatial filter applied to the field of values Q(x′,t) on a neighborhood Δ, x, x′ representing coordinates in the simulation space. The coordinate point x′ is in the neighborhood defined by Δ of the X-coordinate point.

These filtered data c and Σ can be used for training a multilayer neural network 10.

To do this, a learning set is formed associating a graph corresponding to this “coarse” mesh with filtered local combustion quantities Σ at each vertex of this graph.

The vertices of the graph have, as a value, those of the filtered progress variable c. Hereinafter, for clarity, the terms “filtered” may be omitted because they are implicit.

According to one embodiment, of the invention, the vertices of the graph match the vertices of the mesh. However, other embodiments are possible, such as for example considering the dual graph, that is to say the graph in which the vertices match the mesh cells (or cells) of the mesh and not its vertices.

The learning set can be constituted by varying the various instants of a time simulation, by varying the initial conditions, by varying the edge conditions, etc. These variations make it possible to generate different direct numerical simulations which make it possible to populate this learning set and to provide it with robustness and stability against the variations of these parameters in the inference phase.

It is important to note that the input to the multilayer neural network 10 is not a vector of values of the progress variable c, but rather a graph whose vertices bear these values.

Indeed, considering a graph, rather than a vector, makes it possible to take into account the adaptive and non-uniform nature of the mesh. A vector would not make it possible to account for the values not matching points that are uniformly spaced in space, even though these values depend precisely on their location.

Considering an input graph, it is thus possible to solve this problem of “conventional” neural networks, including convolutional neural networks (CNN) only being able to operate on Euclidean spaces such as images (in two dimensions) or texts (one-dimensional sequences).

In addition, the graph natively takes into account the scale of the mesh of the input data. Thus, during the iterative inference (or prediction) phase, no pre-processing is required in order to scale, or re-discretize, the progress variables. This results in a very large gain in the computational complexity of the overall simulation.

In this learning phase S2, a loss function 50 is applied to compare the output of the multilayer neural network 10 with the desired output represented by the corresponding local combustion quantity provided by the filtered direct numerical simulation. This loss function may be conventional in itself, for example based on a mean squared error (MSE) between the two values to be compared.

Conventionally, the result of this comparison (an error) can be introduced into the multilayer neural network in order to change the parameters thereof, typically the synaptic weights. The methodology for modifying these weights may be based on the back-propagation algorithm of the error gradient.

The multilayer neural network 10 is adapted in order to be able to take into account a graph as input data.

The input graph may be defined as a data structure including a set of discrete vertices (or nodes) and a set of edges connecting two vertices.

Such a multilayer neural network 10 may be based on the work undertaken by Scarselli, Franco; Gori, Marco; Tsoi, Ah Chung; Hagenbuchner, Markus; Monfardini, Gabriele (2009). “The Graph Neural Network Model”. IEEE Transactions on Neural Networks. 20 (1): 61-80. doi:10.1109/TNN.2008.2005605. ISSN 1941-0093. PMID 19068426. S2CID 206756462.

The Wikipedia page relating to Graph Neural Networks (GNN) also provides explanations and pointers:

https://en.wikipedia.org/wiki/Graph neural network

One neuron can be associated with each vertex, or node, of the graph. The value associated with the neuron corresponds to the progress variable associated with this vertex.

Such a neural network takes into account the nature of the graph of the inputs by computing the state of a neuron from the states of the neurons of a neighborhood determined by the graph.

This neighborhood may be limited (or not) to the immediately neighboring nodes.

Thus, the inputs of the neural network natively take into account the local nature of the combustion data. The organization of these data in the form of a graph makes it possible to isolate the relevant data for each node, which are limited to the state of the nodes of a local neighborhood.

Considering only relative positions in terms of neighborhood in a mesh, independently of the absolute positions in the space of the combustion chamber, the data structure formed by the graph is additionally invariant to translations and rotations.

For translations, it is understood that only the relative positions of the vertices of the mesh, in terms of links in the graph, are relevant.

Furthermore, if the combustion chamber is turned over, it must operate similarly to the extent that the effects of gravitation are disregarded. A rotation is effectively without effect on the relative positions of the vertices of the graph.

It appears that this structure makes it possible on the one hand to avoid the capture of unnecessary data (since they do not represent a relevant physical reality) that would interfere with the proper convergence of the neural network, but also to capture the same overall information with a much lower degree of freedom. Thus, it is possible to estimate that a graph neural network, such as the one that can be used in the context of the invention, has about 7000 parameters, while a U-Net type convolutional neural network has several million.

The process is typically iterative, so that the output gradually converges towards a stable state representative of the entire graph. This output is, in this case, also a graph, but one in which the values associated with the nodes match the partial combustion quantities.

Although the influence of the value of a node is limited by the notion of neighborhood, the fact of providing a multilayer network allows this influence to propagate on the graph, layer after layer. Among other things, the mainly local nature of the combustion phenomenon enables good performance even with a rather low number of layers. Thus, a network of 4 layers achieves scores equivalent to those which can be achieved with a U-Net type convolutional network.

Thus, the value

$${h}_{i}^{r + 1}$$

associated with a neuron (or vertex) i, at the layer r+1 depends on the values associated with the neurons of the neighborhood N(i) of this neuron i at the previous layer (this neighborhood being defined by the graph) and the synaptic weights W linking the neurons together.

The vertices (or neurons) outside this neighborhood do not influence the neuron in question and do not contribute to the computation of its output value.

According to one embodiment, the following can be written:

$${h}_{i}^{r + 1} = ρ \left({\sum }_{j ε N \left(i\right)} W {h}_{j}^{r}\right)$$

where ρ represents an activation function, for example of the ReLU (“Rectified Linear Unit”) type.

According to a preferred embodiment, an attention mechanism can be implemented according to which the influence of the neighboring neurons is variable. Thus, for a neuron i, an attention a_{i,j} can be defined for all of the neighboring neurons j ∈ N(i). Such a network type may conform to the “Graph Attention Networks” model by Petar Velickovic et al., 2018, arXiv:1710.10903.

The preceding expression can then be written as follows:

$${h}_{i}^{r + 1} = ρ \left({\sum }_{j ε N \left(i\right)} {α}_{i , j} W {h}_{j}^{r}\right)$$

The attention a_{i,j} can for example be expressed by:

$${α}_{i j}^{r} = s o f t m a x \left({e}_{i , j}^{r}\right) = \frac{e x p \left({e}_{i , j}^{r}\right)}{{\sum }_{k ε N \left(i\right)} e x p \left({e}_{i , k}^{r}\right)}$$

where “exp” represents the exponential function, and the values

$${e}_{i , j}^{r}$$

and

$${e}_{i , k}^{r}$$

represent an attention score of the neuron j and k, respectively, for the neuron i.

This attention score depends on the values taken by these neighboring neurons and on an attention vector

$${\vec{a}}^{r}$$

It represents the importance of the value of the neuron j for the neuron i.

According to one embodiment, it may be expressed by:

$${e}_{i , j}^{r} = L e a k y R e L U \left({\vec{a}}^{{r}^{T}} \left({W}^{r} {h}_{j}^{r} \left‖{W}^{r} {h}_{j}^{r}\right)\right)\right)$$

where
_{T} represents the matrix transposition,
. ||. represents the concatenation operation.

LeakyReLU is an activation function of the ReLU (“Rectified Linear Unit”) type, but derivable:
The ReLU function f is defined by f(x)=max(0,x) for all real values of x
The LeakyReLU function is defined by f(x)=max(ε.x,x) for all real values of x. The parameter ε is a strictly positive real number less than ε∈]0.1[. The derivative is then equal to ε when x is strictly negative, which makes it possible to preserve the updating of the weights of a neuron using this activation function.

By presenting the learning set previously disclosed to such a neural network, and by using the loss function and an algorithm for updating the weights (for example of the type with back-propagation of the error gradient), the weights W and a̅ can be fixed. These different weights determine the state of the multilayer neural network and model the knowledge acquired during training.

In a step S3, the model instantiated by the multilayer neural network can be exploited, coupled with a solver in order to simulate a combustion chamber defined by new parameters.

In particular, the multilayer neural network trained in this way can predict local combustion quantities based upon new values of progress variables, by generalization (that is to say, even if these values were not parts of the learning set).

FIG. 6 illustrates the coupling in place between a solver 30 and the multilayer neural network 10, previously trained, for this simulation phase S3.

The multilayer neural network 10 functions as a substitute for a part of the computations of the solver 30 which models a part of the simulated physics, in this case the link between the local composition of the gases (estimated by the progress variable) and the combustion quantity (estimated for example by the flame surface density). Since this link is learned in learning step S2, the solver can be discharged from this part and allowed to manage other aspects (fluid dynamics, turbulence, etc.).

This simulation is an iterative process in which the inputs of the solver comprise the outputs of the neural network, and, conversely, the inputs of the neural network 10 consist of the outputs of the solver 30.

More specifically, the values predicted by the multilayer neural network 10 of a local combustion quantity (for example a flame surface density) are provided as input to the solver 30, at the vertices of the mesh. The solver 30 then provides a progress variable at each vertex of the mesh.

A graph corresponding to the vertices of the mesh is provided to the multilayer neural network 10. Each vertex has a value of the progress variable, obtained by the solver 30. The multilayer neural network provides predicted values of the local combustion quantity (for example, a flame surface density) at these vertices.

According to one embodiment, the solver used for the simulation can be a solver for large-scale simulation. Large-scale simulation (Large-Eddy Simulation or LES) is based on a coarser mesh, as previously explained. This “coarse” mesh corresponds to that on which the learning was carried out in phase S2, after filtering the direct numerical simulation.

One of the benefits of the invention is to allow a relatively loose mesh while retaining the accuracy and convergence properties of the computational fluid dynamics techniques. The advantage of using a loose mesh is, of course, to reduce the computational cost of the simulation. The invention therefore makes it possible to guarantee the same level of accuracy of the simulation as the solutions known in the state of the art, but with a smaller computational cost.

The gain in the computational cost makes it possible, over a constant duration, to test a larger number of sets of parameters for the combustion chamber, and thus to obtain better optimization, or else to expect the same degree of optimization in less time.

In fact, direct numerical simulations (DNS) run on high-performance computers (HPC), with several hundred compute nodes in several days. By comparison, a large-scale simulation (LES), coupled with the multilayer neural network, runs on a handful of compute nodes in a few minutes.

Large-Eddy Simulation (LES) is a method used for modeling turbulence. It consists in filtering the small scales which are modeled, directly computing from same the large scales of the turbulent cascade.

This method was introduced by Joseph Smagorinsky in 1963 in J. S. Smagorinsky, “General Circulation Experiments with the Primitive Equations: I. The basic Experiment”, Monthly Weather Revue, vol. 91, no. 3, 1963, pages 99-16. It makes it possible to calculate a turbulent flow by capturing the large scales for a reasonable cost. The fact that the small-scale medium is reasonably assumed to be isotropic can be disclosed by a simple method.

The simulation tools mentioned above propose modules, or solvers, which make it possible to perform such a large-scale simulation.

In the course of the iterations, the simulation converges, that is to say, there is little variation in a measurement of distance between two consecutive states. The final state provides the simulation of the combustion in the combustion chamber considered.

The output of the solver 30 includes, as has been seen, the simulated progress variables (which are reintroduced toward the neural network 10), but other parameters are, generally, likewise simulated.

One possible step S4 may consist in determining a set of combustion chamber design parameters from the results of the iterative simulation phase S3 for a plurality of envisaged sets of design parameters.

To do this, it is possible to analyze the results of the simulation carried out, and to test new sets of parameters envisaged for the combustion chamber by launching a new simulation S3.

One possible aim is to find the set of design parameters that makes it possible to optimize a temperature profile at the outlet of the chamber in order to obtain the highest temperatures but under the limits of the constituent materials of the combustion chamber.

It is then possible to design a combustion chamber by choosing the set of design parameters corresponding to the simulation that provided the “best” results according to the chosen criteria.

Optionally, once a choice of parameters has been made, a direct numerical simulation (DNS) can be performed in order to confirm the results and validate this set of parameters for the design of the chamber.

A combustion chamber designed according to this set of parameters can then be produced.

Thus, the simulation step S3 can make it possible to navigate a large space of sets of parameters, in order to choose an optimal set and initiate the actual production.

The computational cost is offset to the learning phase S2. The simulation phase S3 is thus lightened, which makes it possible to test a large number of sets of parameters (loop from S4 to S3, without a significant additional cost).

Coupling with the multilayer neural network 10 furthermore allows the large-scale solver 30 to stabilize its convergence and to achieve an accuracy of the simulated results that are better than the known solutions of the state of the art.

In some embodiments, the disclosed techniques may be performed, e.g., on a compute device (e.g., a desktop computer, a cloud-based server, etc.), which may comprise one or more processors operably coupled to a memory and/or non-transitory computer-readable storage devices containing instructions that, when executed by the processor(s), cause the processor(s) to perform the techniques disclosed herein.

Naturally, this invention is not limited to the examples and embodiment disclosed and depicted, but rather is defined by the claims. It is especially capable of numerous variants accessible to a person skilled in the art.

What is claimed is:

1. A method for simulating combustion of a fluid in a combustion chamber, for design of said combustion chamber, comprising:
discretizing (S1) a space of said combustion chamber into a given mesh,
training (S2) a multilayer neural network (10) by means of a learning set associating a graph corresponding to said given mesh, vertices of which have, as a value, progress variables predicted by a computational fluid dynamics simulation (20), with local combustion quantities at said vertices, and according to a loss function (50) configured to minimize an error between output of said neural network and said local combustion quantities; and
iteratively simulating (S3) said combustion which involves, at each iteration:
providing as input to a solver (30) the values predicted by said multilayer neural network (10) of a local combustion quantity at the vertices of said given mesh, in order to obtain a value of a progress variable at each vertex of said given mesh; and
providing to said multilayer neural network a graph corresponding to the vertices of said given mesh, each vertex having a corresponding value of said progress variable, obtained by said solver, in order to obtain predicted values of said local combustion quantity at said vertices.

2. The method according to claim 1, wherein said local combustion quantity is approximated by a flame surface density.

3. The method according to claim 1, further comprising discretizing said space into a second mesh, substantially finer than said given mesh, and wherein said training the multilayer neural network comprises a direct numerical simulation (20) of said combustion, in order to obtain said progress variables and said local combustion quantities at the vertices of said second mesh, then a filtering (40) in order to obtain said progress variables and said local combustion quantities at the vertices of said given mesh.

4. The method according to claim 1, wherein nodes of said graph match the vertices of said given mesh.

5. The method according to claim 1, wherein said solver (30) performs a large-scale simulation.

6. The method according to claim 1, wherein said multilayer neural network (10) takes into account said graph by computing a state of a neuron from states of neighboring neurons of a neighborhood determined by said graph.

7. The method according to claim 6, wherein the state of the neuron is computed based on an influence of said neighboring neurons that is variable according to said neighboring neurons.

8. The method according to claim 1, further including a step (S4) of determining a set of design parameters for said combustion chamber from results of said iterative simulating for a plurality of envisaged sets of design parameters.

9. A device for simulating combustion of a fluid in a combustion chamber, for design of said combustion chamber, comprising:
a means for discretizing a space of said combustion chamber into a given mesh,
a means for training a multilayer neural network (10) by means of a learning set associating a graph corresponding to said given mesh, vertices of which have, as a value, progress variables predicted by a computational fluid dynamics simulation (20), with local combustion quantities at said vertices, and according to a loss function (50) configured to minimize an error between output of said neural network and said local combustion quantities, and
a solver (30) suitable for receiving as input the values predicted by said multilayer neural network (10) of a local combustion quantity at the vertices of said given mesh, in order to obtain a value of a progress variable at each vertex of said given mesh,
wherein said multilayer neural network is suitable for receiving as input a graph corresponding to the vertices of said given mesh, each vertex having a corresponding value of said progress variable, obtained by said solver, in order to obtain predicted values of said local combustion quantity at said vertices.
